(19) United States
(12) Patent Application Publication
(10) Pub. No.: US 2010/0215837 A1
(43) Pub. Date: Aug. 26, 2010

(54) PROCESS FOR MAKING AN ELECTRODE, AN ELECTRODE AND A BATTERY COMPRISING THE ELECTRODE

(76) Inventor: Rhodri Evans, Monmouthshire (GB)

Correspondence Address: MYERS BIGEL SIBLEY & SAJOVEC, PO BOX 37428, RALEIGH, NC, 27627, US

(21) Appl. No.: 12/664,479

(22) PCT Filed: Jun. 18, 2008
(86) PCT No.: PCT/GB2008/002075

§ 371 Date: May 5, 2010

(30) Foreign Application Priority Data
Jun. 19, 2007 (GB) 0711872.2
Jun. 19, 2007 (GB) 0711873.0
Jan. 15, 2008 (GB) 0800680.1
Jan. 15, 2008 (GB) 0800681.9

(51) Int. Cl. B05D 5/12

(52) U.S. Cl. 427/58

(57) ABSTRACT

The invention provides a process for making an electrode for a lead acid battery in which a continuous metal support (26) is pasted with active material to make a continuous strip of electrode material and electrode portions (27) are cut from that strip in which the electrode portions (27) each comprise a body portion (28) and at least one tab portion (29a, 29b) which extends from an edge of the body (28) in a longitudinal direction along the length of the strip of the electrode material (26).

The present invention relates to a process of making an electrode for a lead-acid battery, to the electrode made by the process and to a battery comprising the electrode.

Conventionally, electrode plates for lead-acid batteries comprise an active material supported on a metal support grid. Typically, the electrode plate is provided along one edge with a tab by means of which it is welded to a metal strap which connects the electrodes to the appropriate terminal on the surface of the battery. A known process for preparing electrode plates involves preparing a continuous metal support grid which may be many metres long, applying the active material to each or one side of the grid to form a strip of electrode material, cutting the electrodes from the strip, followed by curing and drying the cut electrodes and then performing finishing operations such as trimming and shaping the tab to the desired size. The metal support strip is typically prepared by continuous casting, by punching the desired grid pattern into a continuous metal strip, or by making a predetermined pattern of cuts in a continuous metal strip and then expanding the strip in a transverse direction to give an expanded metal grid. Continuous metal support grids prepared by the above-mentioned methods usually have regions of blank metal sometimes known as ‘rails’ running longitudinally along their edges and often parallel to each other. Conventionally, the electrode plates are cut in a transverse orientation with respect to the strip of electrode material such that the plate tabs are cut from one of the regions of blank metal.

One problem with those existing methods is that to date the electrode plates made have been limited in size, and are not long enough for use in larger/taller batteries, for example, of the type used in motive power applications.

Larger plates, for example, plates having a length of 600 millimetres have conventionally been made by a book mould casting process in which the metal supports are cast individually in the desired size. Those metal supports typically have a metal frame which extends around the periphery of the plate to improve strength and current flow and are typically thicker, for example, having a thickness of around 3 to 7 millimetres or so, than metal supports cut from continuous metal grids as described above. However, the book mould casting process can have cost disadvantages as compared to processes in which metal supports are formed from a continuous grid.

The invention provides in a first aspect a process for making an electrode for a lead-acid battery comprising the steps of:
a) providing a continuous metal support which is a continuous cast metal support or a punched strip metal support;
b) pasting active material onto the continuous metal support to make a continuous strip of electrode material; and
c) cutting an electrode portion from the strip of electrode material in which the electrode portion comprises a body portion and at least one tab portion which extends from an edge of the body portion in a longitudinal direction along the length of the strip of electrode material.

The term “continuous cast metal support” as used herein refers to a metal support which has been cast as a continuous strip having one or more regions of grid formed by the casting process. The term “punched strip metal support” as used herein refers to a continuous metal support which is formed by perforating i.e. punching holes in a continuous strip of blank metal to form one or more grid regions therein. The continuous strip of blank metal may in turn have been formed, for example, by cold rolling a metal ingot or by a continuous casting process.

The continuous metal support in the process of the first aspect of the invention preferably also includes metal cross bars extending transversely across the strip. Preferably, the cross bars have a width (as measured in the longitudinal direction of the strip) in the range of from 2 to 10 millimetres, preferably from 2 to 5 millimetres. Optionally the cross bars are tapered. Preferably, the cross bars are spaced at a regular interval in the range of from 30 to 400 millimetres along the continuous metal support.

In a second aspect the invention provides a process for making an electrode for a lead-acid battery comprising the steps:
a) providing a continuous metal support in the form of a metal strip having a region of blank metal extending along each longitudinal edge of the strip, metal cross bars extending transversely across the strip and regions of metal grid;
b) pasting active material onto the continuous metal support to make a continuous strip of electrode material; and
c) cutting an electrode portion from the strip of electrode material in which the electrode portion comprises a body portion and at least one tab portion which extends from an edge of the body portion in a longitudinal direction along the length of the strip of electrode material.

The continuous metal support of the process of the second aspect of the invention may be formed by any conventional method. Preferred methods include continuous casting, perforating or punching a metal strip or cutting and expanding a metal strip. Preferably, the continuous metal support is made by continuous casting of the metal support or by punching holes in a metal strip formed by casting or cold rolling.

The term “cross bar” as used herein refers to a region of blank metal which extends transversely across the continuous metal strip which connects together the regions of blank metal which extend longitudinally along each edge of the strip. The presence of cross bars in the metal support may improve overall plate conductivity and may therefore allow a reduction in the width of the conduction rail or rails, thereby optimising the ratio of active paste to inert material. The cross bars will advantageously have a width (as measured in the longitudinal direction of the strip) in the range of from 2 to 10 millimetres, preferably in the range of from 2 to 5 millimetres. Optionally, the cross bars are tapered so that the thickness changes progressively in the direction transverse to the length of the strip. Where the cross bars are tapered, the width of the cross bars at the narrowest point is preferably at least 2 millimetres and is more preferably in the range of from 2 to 5 millimetres (as measured in the longitudinal direction of the strip).

Preferably the cross bars are spaced at regular intervals along the length of the continuous metal support. Preferably, the cross bars are spaced at a regular interval in the range of from 30 to 400 millimetres along the length of the continuous metal support

The present invention also provides a process for making an electrode for a lead-acid battery comprising the step of cutting an electrode portion from a strip of electrode material comprising active material carried on a continuous metal support, in which the electrode portion comprises a body portion and at least one tab portion which extends from an edge of the body portion in a longitudinal direction along the length of the strip of electrode material.

The processes of the invention make it possible to produce longer electrode plates from a continuous strip of electrode material prepared using known methods because the electrode portion is cut from the strip in a longitudinal direction with the tab portion extending from the body portion in a longitudinal direction along the length of the strip. Preferably, the longest dimension of the body portion lies in a longitudinal direction along the length of the strip of the electrode material. Preferably, the body portion of the electrode is rectangular.

The metal support of the body portion of the electrode portion formed in the process of the invention preferably includes one or more cross bars, more preferably two or more cross bars, and optionally three or more cross bars. Preferably, the metal support of the body portion includes at least one cross bar which is bounded on both sides by grid regions and which does not extend along an edge of the metal support. Typically, the tab portions are not cut from the cross bar or cross bars of the metal support.

The processes of the invention are suitable for making both anodes and cathodes and are applicable to a wide range of lead-acid battery technologies, for example, valve regulated absorbent glass mat (AGM) or gelled electrolyte batteries. The strip of electrode material may be a strip of any material which is suitable for making electrodes for a lead-acid battery, and which comprises active material supported on a continuous metal support. The active material may be any active material suitable for use in a lead-acid battery electrode.

Any suitable metal may be used for the metal support. Preferably, the metal support is of lead or a lead alloy. Typically, the continuous metal support will include at least one grid region and at least one blank metal region. The blank metal region or regions can add strength and can help to improve current flow in the finished electrode. The grid regions optionally account for between 50% and 95% of the area of the continuous metal support and provide a means for the active material to key to the metal support, as well as minimising the use of expensive metal such as lead. The continuous metal support preferably has a thickness in the range of from 0.4 to 5 millimetres, preferably from 0.8 to 4 millimetres and more preferably from 1.0 to 3.0 millimetres.

The word “continuous” as used herein in connection with the metal support means that the metal support has a length which is significantly greater than the length of the electrode portion and preferably extends to the full length of the strip of electrode material. The continuous metal support may have any suitable length. For example, the continuous metal support may have a length in excess of 50 metres, and in some cases more than 100 metres. Optionally the continuous metal support may be stored in coil form.

The terms “electrode” and “electrode plate” are used herein interchangeably.

Preferably, the continuous metal support includes a central grid region which is bounded on each side by regions of blank metal which extend along each edge of the continuous metal support. The grid region of the continuous metal support may have any pattern suitable for carrying the active material. Preferably, the grid is a rectilinear grid, for example, the grid pattern is optionally a rectangular grid. The regions of blank metal which extend along the edges of the continuous metal support are conventionally known as selvedge rails.

Optionally the active material is pasted across the full width of the continuous metal support. Alternatively, the active material may be pasted over only part of the width of the continuous metal support, for example, over all of a central grid region and over only part of the selvedge rails. In that way, the amount of active material required to be recycled may be reduced. Where only a part of the width of the continuous metal support is pasted with active material it is possible that the tab portions will be in the unpasted area. Preferably, the active material paste applied to the metal support has a density in the range of from 2.0 to 5.0 g/cm³.

In the processes of the invention, it is important that each tab portion is cut from a region of blank metal of the continuous metal support. The continuous metal support may also have a centrally disposed region of blank metal extending along its length from which the tab portion may be cut. Optionally, however, the or each tab portion is cut from a region of blank metal which extends along an edge of the continuous metal support. Where the body portion of the electrode portion is rectangular the region of blank metal optionally extends along a long edge of the body portion with the tab extending from one of the shorter edges at or very close to the corner of the long edge.

Where the electrode portion comprises more than one tab portion, for example, two tab portions, those tab portions are optionally cut from the same region of blank metal of the continuous metal support. For example, the body portion may have two tab portions, each cut from the same selvedge rail. Alternatively, the tab portions may be cut from separate regions of blank metal in the continuous metal support. For example, the body portion may have two tab portions, each cut from a different selvedge rail.

In a preferred embodiment, the body portion is rectangular and regions of blank metal extend along both the longer sides of the metal support and a tab portion extends from each of those regions of blank metal. Those regions of blank metal preferably extend along at least 70% of the length of each of the longer sides of the body portion and more preferably extend along the full length of each of the longer sides of the body portion. Preferably, the two tab portions extend from opposite ends of the body portion. In order to reduce the amount of lead in the electrode, any region of blank metal which extends along a lengthwise edge of the continuous metal support strip may be cut such that the region of blank metal tapers in a direction away from a tab portion extending from that region of blank metal. In that embodiment, the region of blank metal grows wider towards its union with the tab and is therefore wider in the areas of higher current flow. Where the electrode has two tabs each tab being integral with a respective region of blank metal, both those regions are preferably tapered.

In a further embodiment, the continuous metal support may include at regular intervals along its length regions of blank metal which extend across the strip in a transverse direction (in addition to any cross bars). In that embodiment, in the cutting step the or each tab portion is optionally cut from one of those transversely extending blank regions. The tab portion or portions may thus be formed at any desired point across the width of the strip of electrode material and the transversely extending regions of blank metal provide added strength and stiffness. The strip of electrode material is optionally provided with indexing marks to allow alignment of the cutting operation with the transverse regions of blank metal thereby ensuring that the tab portions are within those transversely extending blank regions of the metal support.

The electrode portion optionally has one tab portion. The electrode portion optionally has two or more tab portions. Preferably, the electrode portion comprises two tab portions. The two tab portions may extend from the same edge of the body portion. Preferably, however, the two tab portions extend from different, opposing edges of the body portion.

Where the electrode portion has two or more tab portions, one of those tab portions may be present for process reasons only and be removed prior to assembly of the cell. Such tabs are referred to as “false lugs”.

The electrode portions may be cut from a strip of electrode material with any suitable cutter. For example, a rotating cutting die.

The continuous metal support may be of any suitable material. Preferably, the continuous metal support is of lead or a lead alloy.

The process may include, prior to the cutting step, the steps of pasting the active material onto the continuous metal support and, optionally, applying an outer covering, for example, a paper material to the outer surfaces of the material. Where an outer covering is used it will typically be applied to both faces of the strip in order to prevent the electrode portions cut from the strip from sticking together during subsequent processing steps. Optionally the outer covering is paper.

Optionally the process also includes, after the cutting step, one or more finishing steps, for example, the active material may be cured in an oven and then dried at a higher temperature. Preferably, the plates are cured for between 12 and 48 hours. The curing will generally involve elevated temperatures and humidity. Preferably, after curing the plates are dried for between 12 and 36 hours. The drying will generally be carried out at an elevated temperature. Moreover, the tab portion may be stripped of active material and/or subjected to further shaping steps or a milling step to grind it down to a desired thickness.

The electrodes may then be assembled into a battery by conventional methods.

In a further aspect, the invention provides a process of making an electrode for a lead-acid battery comprising the steps of:
a) preparing a continuous metal support by continuous casting or by perforating a strip of metal;
b) pasting an active material onto the continuous metal support, and optionally applying an outer covering to the external surfaces of the active material, to form a strip of electrode material;
c) passing the strip of electrode material through a cutter and cutting electrode portions from the strip, each electrode portion comprising a generally rectangular body portion and at least one tab portion, the length of the body portion in a longitudinal direction with respect to the strip being greater than the width of the body portion in a direction transverse to the length of the strip and the at least one tab portion extending from a shorter side of the body portion in a longitudinal direction with respect to the length of the strip;
d) curing and drying the active material; and
e) optionally removing any active material from the tab portion.

In a yet further aspect, the invention provides a process for making a battery comprising the steps of:
a) providing a continuous metal support in the form of a metal strip having a selvedge rail at each longitudinal edge, the selvedge rails being connected at regular intervals along the length of the strip by transversely extending cross bars and the selvedge rails and the cross bars together defining between them regions of metal grid;
b) pasting an active material onto the continuous metal support, and optionally applying an outer covering to the external surfaces of the active material, to form a strip of electrode material;
c) passing the strip of electrode material through a cutter and cutting electrode portions from the strip, each electrode portion comprising a generally rectangular body portion and at least one tab portion, the length of the body portion in a longitudinal direction with respect to the strip being greater than the width of the body portion in a direction transverse to the length of the strip and the at least one tab portion extending from a shorter side of the body portion in a longitudinal direction with respect to the length of the strip;
d) curing and drying the active material; and
e) optionally removing any active material from the tab portion.

The invention further provides an electrode for a lead-acid battery obtainable by the process of the first aspect of the invention and having a body portion comprising an active material supported on a metal support and at least one tab extending from the body portion, in which the metal support includes at least one elongate region of blank metal which extends lengthwise along the electrode.

The invention further provide an electrode for a lead-acid battery obtainable by the process of the second aspect of the invention and having a body portion comprising an active material supported on a metal support and at least one tab extending from the body portion in which the metal support includes elongate regions of blank metal which extend along two edges of the electrode, one or more cross bars which extend orthogonally from one region of blank metal to the other region of blank metal and one or more regions of metal grid.

The electrode may be of any suitable shape. In a preferred embodiment, the body portion of the electrode is a generally rectangular plate and the or each tab extends from one of the shorter sides of the plate.

Preferably, the tab or tabs are each integral with a region of blank metal in the metal support which extends along a long side of the body portion. Alternatively, the tab or tabs may each be integral with a region of blank metal extending along a short side of the body portion.

The electrode may have a single tab. Preferably, the electrode has two or more tabs. Those two or more tabs may extend from opposite shorter edges of the rectangular body portion of the electrode. The two tabs may extend from opposite corners of the body portion of the electrode.

The electrode may have a length of at least 100 millimetres, preferably at least 250 millimetres. The electrode is optionally no longer than 1300 millimetres. Advantageously, the electrode has a width in the range of from 100 millimetres to 600 millimetres.

The electrode may be an anode or a cathode. The electrode of the invention may be incorporated in a battery using conventional assembling methods. For example, a number of electrodes may be assembled into an electrode stack of alternating positive and negative electrodes. In such a stack, the plates are aligned so that the tabs of the negative plates form a first row and the tabs of the positive plates form a second row parallel to the first. The plate stack is then inverted and lead straps are cast onto the rows of lugs. The stack is then inserted into a battery box and a lid welded on top.

In one embodiment, the electrode of the invention has one or more tabs located at or close to a corner of the body portion of the electrode. In the finished battery those tab portions will be very close to the side wall of the battery container and it will therefore be necessary to adapt the container and lid accordingly. In a preferred embodiment, the lid of the battery container contains one or more metal inserts, each insert having one or more apertures and each aperture being shaped to accommodate a plate tab such that the plate tabs enter the apertures as the lid is fitted onto the battery. Before the fitting of the lid, the tabs are welded to the metal inserts. The metal inserts include means for attaching a cable and act as the battery terminals. Such a battery is described in our co-pending patent application GB 0619444.3 filed 2 Oct. 2006 and is particularly well suited to accommodating electrodes in which the plate tabs are very close to a side wall of the battery.

The invention also provides in a further aspect an electrode for a lead-acid battery having a rectangular body portion having a length of at least 100 millimetres and which comprises active material supported on a metal support having a substantially uniform thickness in the range of from 0.5 to 4 millimetres, the electrode further comprising one or more tabs projecting from the metal support along the shorter side of the body portion.

The metal support of the electrode is formed from cutting the required shape from a strip of continuous metal support. Typically that strip of metal support has been pasted with active material. The metal support will typically include a grid region. The grid is preferably rectilinear, for example, a rectangular grid. The metal support will typically comprise at least one region of blank metal which is elongate and extends along the length of the body portion. The or each tab may be integral with such an elongate region of blank metal.

The invention provides in a further aspect a lead-acid battery comprising one or more electrodes according to the invention. Preferably, all the electrodes in the battery are made according to the process of the invention. The battery may be a 2V battery. Alternatively, the battery may by a multi-cell battery having a higher voltage, for example, 6 or 12 volts.

Embodiments of the invention will now be described for the purposes of illustration only with reference to the following figures in which:

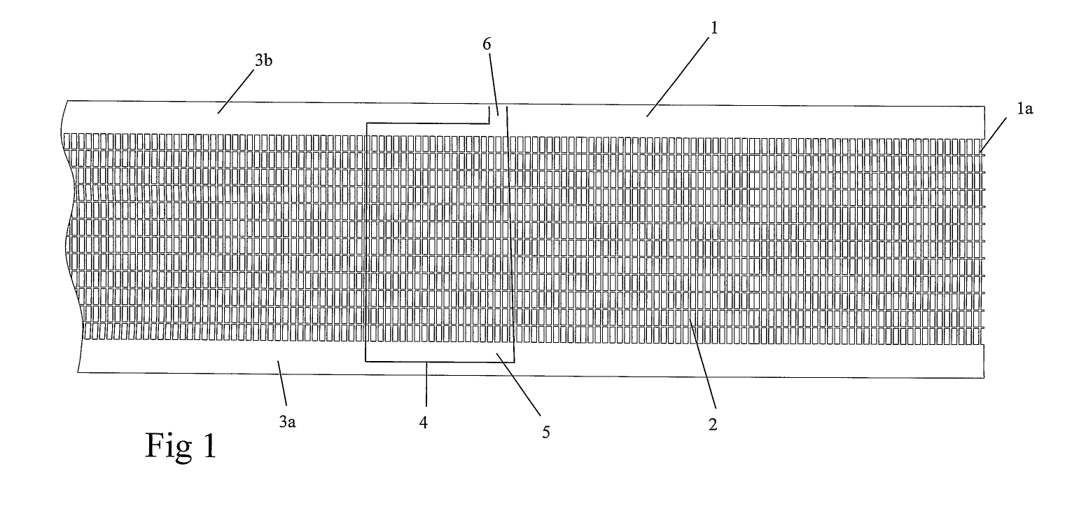

FIG. 1 shows schematically part of a continuous metal support and an electrode portion to be cut according to a known process;

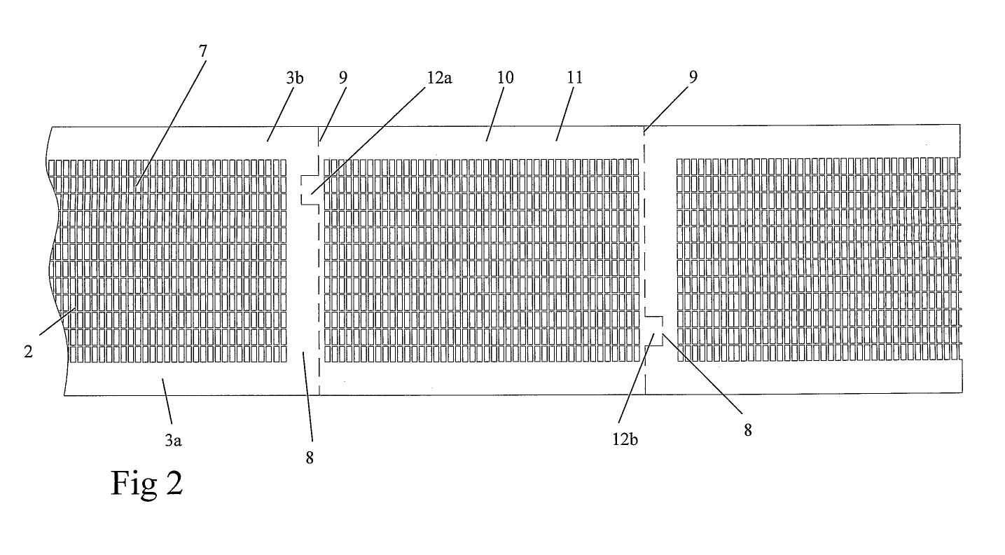

FIG. 2 also shows schematically part of a continuous metal support having regions of blank metal extending transversely across the metal support;

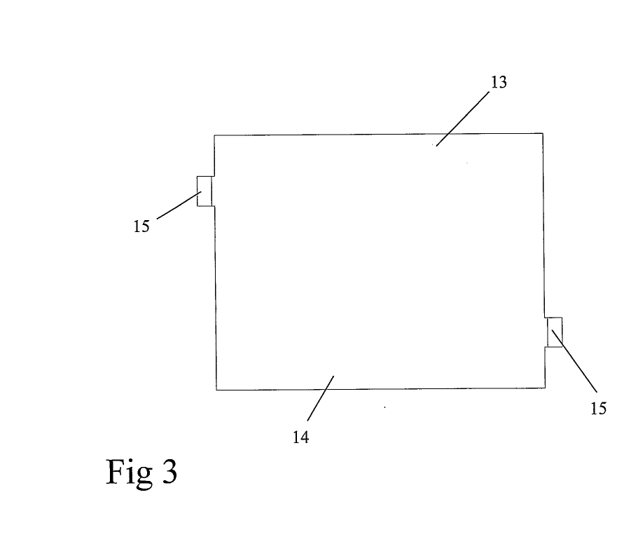

FIG. 3 shows schematically an electrode which has been cut from a strip of electrode material including the metal support of FIG. 2;

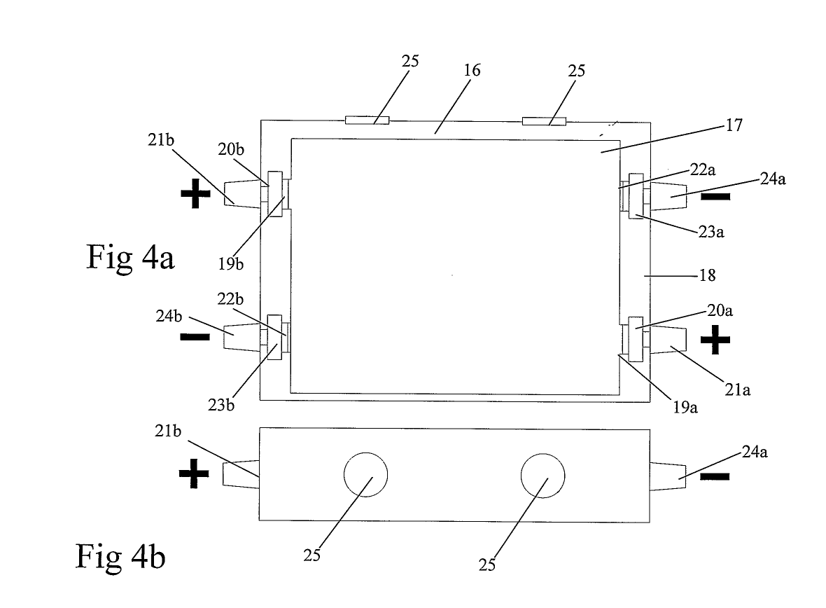

FIG. 4a shows schematically a horizontal cross-section through an assembled battery including the electrode of FIG. 3;

FIG. 4b shows schematically a view from the front of the battery of FIG. 4a;

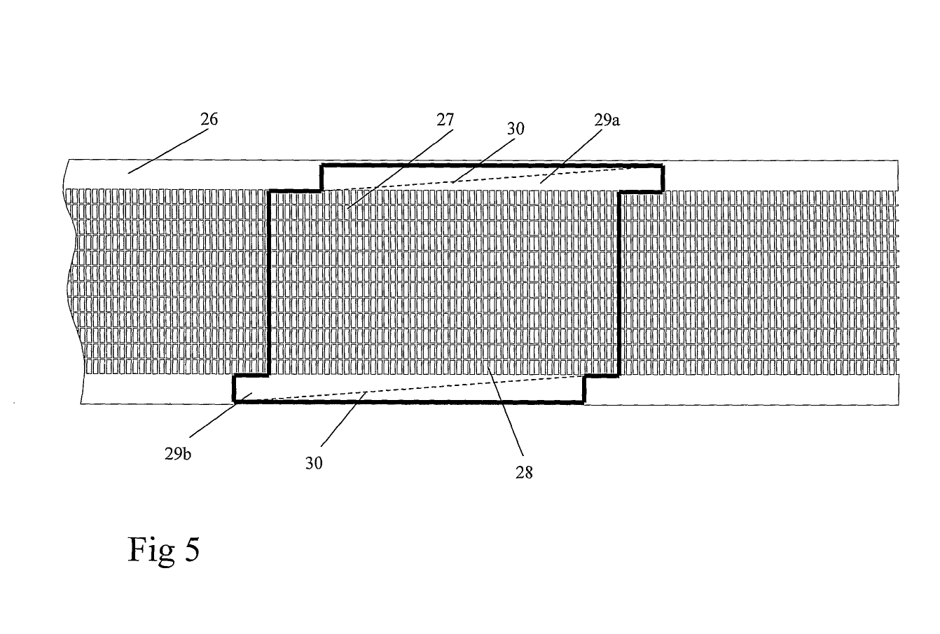

FIG. 5 shows schematically a second continuous metal support having the position of a second electrode according to the invention marked upon it;

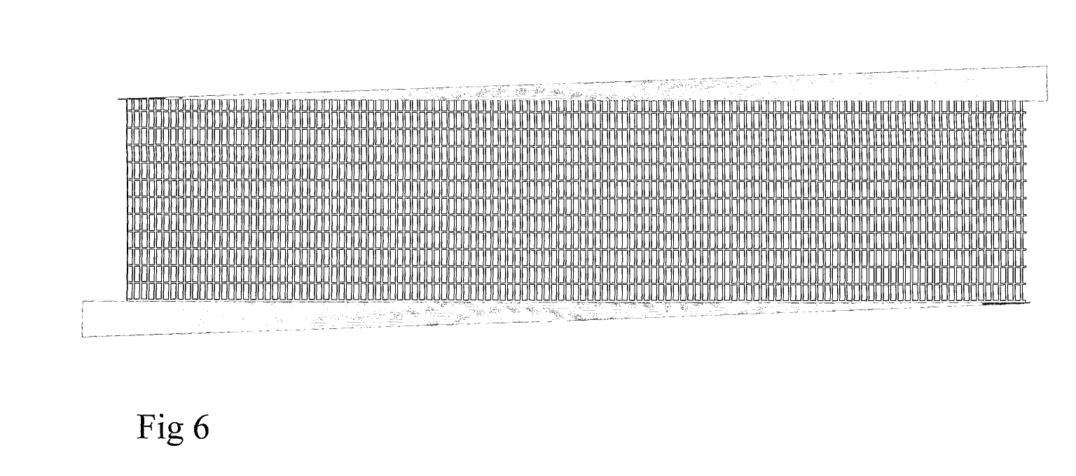

FIG. 6 shows schematically an electrode cut from a strip of electrode material including the metal support of FIG. 5; and

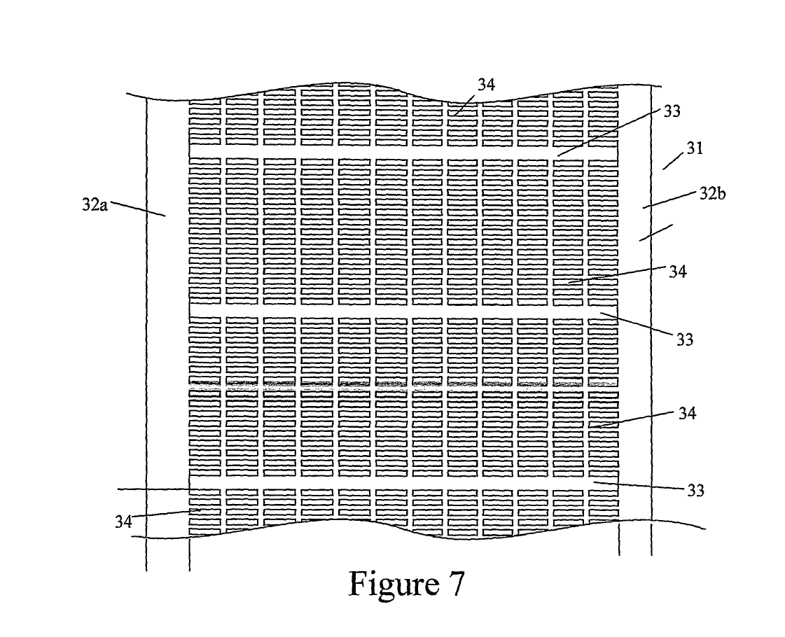

FIG. 7 shows part of an alternative continuous metal support for use in the process of the invention.

FIG. 1 shows schematically one end of a continuous metal support 1. The metal support 1 has a length of over 100 metres. As can been seen in FIG. 1, the continuous metal strip 1 terminates at end la (the other end of the continuous metal support is not shown in FIG. 1). Continuous metal support 1 has a central grid area 2 which is bounded on each side by regions of blank metal 3a and 3b which run along the edges of the continuous metal support 1. Each region of blank metal 3a and 3b, which are conventionally referred to as ‘rails’, runs the full length of the continuous metal support 1.

The continuous metal support 1 has a thickness of 1.1 millimetres. The metal support can optionally be formed by continuous casting of lead or lead alloy, or by rolling or casting a strip and punching holes in the strip.

Marked on FIG. 1 is the outline 4 of an electrode portion which is to be cut from the strip in the conventional way. The electrode portion 4 includes a body portion 5 which is generally rectangular and has at one corner a tab portion 6. As can be seen from FIG. 1, the conventional orientation of the electrode portion is with its longer sides running transversely across the continuous metal support such that the shorter sides are cut from the regions of blank metal 3a, 3b running along the edges of a continuous metal support 1. The tab 6 extends from one of those short sides in a transverse direction across the metal support 1.

A known way of manufacturing electrodes involves taking the continuous metal support 1 and passing it through a pasting station in which active material paste is applied to one or both the sides of the continuous metal support 1 and a paper layer is applied to both external faces of that active material thereby forming a strip of electrode material. From that strip electrode portions such as the one shown in outline 4 are cut. Typically, the cutting operation involves passing the strip of electrode material through a guillotine or a cookie cutter (a rotating cutting die), collecting the cut electrode portions and recycling the scrap material. The cut electrode portions are, first of all, cured and then dried at a higher temperature. Finally, the active material is stripped from the tab portion and the tab is machined to the desired size and thickness. The finished electrode is then ready for assembly in a battery.

FIG. 2 shows schematically an end portion of a continuous metal support 7 for use in one embodiment of the invention. The continuous metal support 7 is generally similar to the one shown in FIG. 1 having a central grid area 2 being bounded on each side by a region of blank metal 3a, 3b (rails). However, at regular intervals along its length the continuous metal support 7 is provided with a region of blank metal 8 which extends transversely across the width of the continuous metal support 7 thereby dividing central grid area 2 into rectangular areas. The dashed lines 9 shown in FIG. 2 depict an electrode portion 10 cut according the process of the invention from a strip of electrode material including the continuous metal support 7. As can be seen from FIG. 2, the electrode portion 10 has a rectangular body portion 11 and two tab portions 12a and 12b which extend from opposite shorter sides of the body portion. The electrode portion 10 is orientated such that its length lies longitudinal to the length of the continuous metal support 7 such that the areas of blank metal 3a, 3b run down the long sides of the body portion 11 and the tab portions 12a and 12b are each cut from one of the transversely extending regions of blank metal 8. As can be seen, the length of the electrode portion 10 is greater than the width of the continuous metal support 7 and the tab portions 12a and 12b extend from the body portion 11 in a longitudinal direction.

To make an electrode according to the process of the invention, the metal support strip 7 is pasted with active material and an outer covering is applied in the conventional way to form a strip of electrode material which is then passed through a cutter arranged to cut out electrode portions as shown in FIG. 2. Those electrode portions are then collected, dried and finished in the conventional way to make a dual tab electrode. It will be appreciated that once the continuous metal support 7 is pasted with active material the continuous regions of blank metal 8 which extend transversely across the metal support 7 are obscured. That continuous metal support 7 may therefore be provided with index marks such as notches in one or both edges to indicate the locations of those transversely extending regions of blank metal 8, thereby allowing accurate alignment of the cutting tool relative to those regions 8.

FIG. 3 shows schematically an electrode 13 prepared as described above in relation to FIG. 2. Electrode 13 has a rectangular body portion 14. Each of the short edges of the rectangular body portion 14 is provided with a tab 15 which has been stripped of active material and milled to the desired thickness. It will be appreciated from FIGS. 2 and 3 that a continuous border of blank metal (the regions of blank metal 3a, 3b which run along the long sides of the body portion 14 of the electrode 13 together with the inner regions of blank metal which run along the shorter sides) extends around the periphery of the metal support in the body portion 14 thereby providing strength and stiffness to the finished electrode 13 and improving the current flow within the electrode.

FIG. 4a shows schematically a cross-section in a horizontal plane through a battery 16 including electrodes of the type shown in FIG. 3. The battery 16 includes a stack of electrode plates 17 held in a container 18. The plate tabs projecting from the positive plates are aligned in two rows 19a and 19b upon which are welded lead straps 20a and 20b which are integral with the positive terminals 21a and 21b which project through apertures in the container 18. In a similar way, the plate tabs for the negative plates are aligned in two rows, 22a and 22b, which are welded into straps 23a and 23b which are integral with negative terminals 24a and 24b. One side of the container 18 is provided with vents 25 for the release of gasses. The batteries shown in FIGS. 4a and 4b is a two volt cell. If desired, a number of the batteries can be connected together in series to give a battery of greater voltage, for example, twelve such cells could be connected together in series to give a 24 volt battery.

FIG. 5 shows schematically a further continuous metal support strip 26, which corresponds generally to the metal support strip shown in FIG. 1. FIG. 5 also shows the outline of an electrode portion 27 which is to be cut out according to a second embodiment of a process of the invention. As can be seen from FIG. 5, the electrode portion 27 is orientated on the continuous metal support strip 26 with its length running longitudinally. The electrode portion 27 has a generally rectangular body portion 28. Extending from opposite short sides of that body portion 28 are two tab portions 29a and 29b which are cut from the regions of blank metal running along the edges of the metal support strip. Those two tab portions 29a and 29b extend from the body portion 28 longitudinally with respect to the continuous metal support 26. In the process of the invention according to the embodiment in FIG. 5, the continuous metal support 26 is pasted with active material in the conventional way and the electrode portions 27 are cut from it. Those electrode portions 27 abut each other along the length of the strip of electrode material thereby minimising waste. If it is desired to reduce the amount of lead in the electrode plate thereby reducing the cost, the regions of blank metal can be trimmed along the dotted lines 30 as shown in FIG. 5, either at the same time as the electrode portions 27 are cut from the strip of electrode material or in a subsequent stage. In that way the regions of blank metal are trimmed such that they taper away from the tab portions 29a and 29b. The trimmed edge may be straight or curved.

In the embodiment of FIG. 5 the short edges of the electrode portions 27 need not coincide with any transversely-extending region of blank metal in the continuous metal support and it is therefore possible to change the length of the plates being cut without changing the strip of electrode material.

FIG. 6 shows schematically an electrode portion cut according to the embodiment of FIG. 5 in which the regions of blank metal extending along the long sides of the body portion of the electrode portion have been trimmed so that they taper in a direction away from the tab portions. In that way, the use of lead or lead alloy is reduced whilst still providing very efficient current flow through the electrode. It will be appreciated, however, that relatively long electrodes according to this embodiment should be handled carefully in order to reduce flexing of the electrodes.

FIG. 7 shows part of a continuous metal support 31 for use in an alternative embodiment of the processes of the invention. The continuous metal support 31 includes two regions of blank metal known as selvedge rails 32a and 32b which each extend along a respective longitudinal edge of the continuous metal support 31. Those regions of blank metal 32a and 32b each have a width (measured in a direction transverse to the length of the continuous metal support 31) of 10 millimetres. Extending between the two regions of blank metal 32a and 32b are metal cross bars 33. The metal cross bars 33 each have a width (measured in a direction longitudinal with respect to the length of the continuous metal support) of 5 millimetres and extend across the continuous metal support connecting one region of blank metal 32a with the other 32b. The cross bars 33 are arranged at a regular interval of 70 millimetres along the length of the continuous metal support 31 and are orthogonal to the continuous regions of blank metal 32a and 32b. In the regions defined between the regions of blank metal 32a and 32b and the cross bars 33 holes have been punched to form rectangular grid areas 34.

When the metal support 31 is pasted with active material and cut into electrode portions, each electrode portion will include at least one cross bar 33, and preferably two or more cross bars 33. The cross bars 33 improve overall conductivity of the finished electrode plate.

In the processes of the invention the continuous metal support 31 is pasted with active material and cut into lengths suitable for use as electrode plates as described previously. Each length of cut electrode plate will desirably include one or more of the cross bars 33. For example, a plate may include five cross bars 33. Those cross bars 33 improve the current flow within the electrode plate and provide additional strength.

Many variations of the above described embodiments will be apparent to the skilled person and so for the purposes of ascertaining the scope of the present invention regard should be had to the appended claims.

1-46. (canceled)

47. A process for making an electrode for a lead-acid battery comprising the steps of:
a) providing a continuous metal support which is a continuous cast metal support or a punched strip metal support;
b) pasting active material onto the continuous metal support to make a continuous strip of electrode material; and
c) cutting an electrode portion from the strip of electrode material in which the electrode portion comprises a body portion and at least one tab portion which extends from an edge of the body portion in a longitudinal direction along the length of the strip of electrode material.

48. A process as claimed in claim 47 in which the longest dimension of the body portion lies in a longitudinal direction along the length of the strip of electrode material.

49. A process as claimed in claim 47 in which the body portion is generally square or rectangular.

50. A process as claimed in claim 47 in which the metal support includes a rectilinear grid region.

51. A process as claimed in claim 47 in which the continuous metal support includes a central grid region bounded on each side by regions of blank metal which extend along each edge of the continuous metal support.

52. A process as claimed in claim 51 in which the or each tab portion is cut from a region of blank metal which extends along an edge of the continuous metal support.

53. A process as claimed in claim 52 in which the region of blank metal which extends along the lengthwise edge of the continuous metal support is cut such that following the cutting the region of blank metal tapers in a direction away from the tab portion extending from that region of blank metal.

54. A process as claimed in claim 47 in which the continuous metal support includes at regular intervals along its length regions of blank metal which extend across the strip in a transverse direction and in which in the cutting step the or each tab portion is cut from one of those transversely extending blank regions.

55. A process as claimed in claim 53 in which the strip of electrode material is provided with indexing marks.

56. A process as claimed in claim 47 in which the electrode portion comprises two or more tab portions.

57. A process as claimed in claim 47 in which the electrode portion is cut from the strip of electrode material by a rotating cutter, a guillotine or a punching die.

58. A process as claimed in claim 47 in which the continuous metal support is of lead or lead alloy.

59. A process as claimed in claim 47 which includes, after the cutting step, one or more finishing steps.

60. A process for making an electrode for a lead-acid battery comprising the steps of:
a) providing a continuous metal support in the form of a metal strip having a region of blank metal extending along each longitudinal edge of the strip, metal cross bars extending transversely across the strip, and regions of metal grid;
b) pasting active material onto the continuous metal support to make a continuous strip of electrode material; and
c) cutting an electrode portion from the strip of electrode material in which the electrode portion comprises a body portion and at least one tab portion which extends from an edge of the body portion in a longitudinal direction along the length of the strip of electrode material.

61. A process as claimed in claim 60 in which the body portion is generally square or rectangular.

62. A process as claimed in claim 60 which the or each tab portion is cut from a region of blank metal which extends along an edge of the continuous metal support.

63. A process as claimed in claim 62 in which the region of blank metal which extends along the lengthwise edge of the continuous metal support is cut such that following the cutting the region of blank metal tapers in a direction away from the tab portion extending from that region of blank metal.

64. A process as claimed in claim 60 in which the cross bars are spaced at regular intervals along the length of the continuous metal support.

65. A process as claimed in claim 64 in which the cross bars are spaced at a regular interval in the range of from 30 to 400 millimetres.

66. A process as claimed in claim 60 in which the cross bars have a width in a longitudinal direction with respect to the continuous metal support in the range of from 2 millimetres to 10 millimetres.
